(19) United States
(12) Patent Application Publication
(10) Pub. No.: US 2021/0024086 A1
(43) Pub. Date: Jan. 28, 2021

(54) AUTONOMOUS DRIVING CONTROL SYSTEM AND METHOD, COMPUTER SERVER AND AUTONOMOUS VEHICLE

(71) Applicant: Beijing Tusen Weilai Technology Co., Ltd., Beijing (CN)

(72) Inventors: Yuhe JIN, Beijing (CN); Nan WU, Beijing (CN)

(21) Appl. No.: 17/066,415

(22) Filed: Oct. 8, 2020

Related U.S. Application Data
(63) Continuation of application No. PCT/CN2018/105465, filed on Sep. 13, 2018.

(30) Foreign Application Priority Data
Apr. 8, 2018 (CN) 201810305051.3

(51) Int. Cl. B60W 60/00; B60W 10/30; B60W 10/20; B60W 10/04; B60Q 1/50; B60W 30/14; B60W 10/18; B60W 30/02; B60W 50/14

(52) U.S. Cl. CPC B60W 60/001; B60W 10/30; B60W 10/20; B60W 10/04; B60Q 1/50; B60W 30/143; B60W 2520/00; B60W 30/02; B60W 50/14; B60W 2510/20; B60W 2510/182; B60W 2050/146; B60W 10/18

(57) ABSTRACT

The present disclosure provides an autonomous driving control system and method, a computer server, and an autonomous vehicle, for controlling autonomous driving of an autonomous vehicle. The system includes: a receiving unit configured to receive decision information; a light control unit configured to generate light control information based on the decision information; a lateral control unit configured to generate lateral control information based on the decision information; a longitudinal control unit configured to generate longitudinal control information based on the decision information; a modifying unit configured to modify one or more parameters in the lateral control information and the longitudinal control information; and a transmitting unit configured to transmit the light control information and the modified lateral control information and longitudinal control information to a vehicle controller.

The present document is a continuation of and claims priority to International Application No. PCT/CN2018/105465, filed Sep. 13, 2018, and which claims priority to Chinese Patent Application No. 201810305051.3, titled “AUTONOMOUS DRIVING CONTROL SYSTEM AND METHOD, COMPUTER SERVER AND AUTONOMOUS VEHICLE”, filed on Apr. 8, 2018, the content of which is incorporated herein by reference in its entirety.

### TECHNICAL FIELD

The present disclosure relates to autonomous driving technology, and more particularly, to an autonomous driving control system, an autonomous driving control method, a computer server, and an autonomous vehicle.

### BACKGROUND

Currently, with the development of the autonomous driving technology, autonomous vehicles in particular have become one of the development trends of future vehicles. For goods transportation by trucks, drivers driving trucks for long-distance transportation are prone to accidents due to fatigue, and at least two to three drivers are typically required for each truck, resulting in high costs. Autonomous driving of vehicles can not only emancipate the drivers and reduce labor costs, but also avoid accidents caused by drivers who are fatigued, drunk, influenced by drugs, or distracted, thereby reducing accident rates.

However, for control techniques for autonomous vehicles, both traditional automakers and high-tech companies are currently in the race of exploration, experimentation, and research and development, and have not yet disclosed effective solutions for controlling autonomous vehicles.

### SUMMARY

In view of the above problem, the present disclosure provides an autonomous vehicle control system, for controlling autonomous driving of an autonomous vehicle.

In a first aspect, according to an embodiment of the present disclosure, an autonomous vehicle control system is provided. The system includes: receiving unit configured to receive decision information; a light control unit configured to generate light control information based on the decision information; a lateral control unit configured to generate lateral control information based on the decision information; a longitudinal control unit configured to generate longitudinal control information based on the decision information; a modifying unit configured to modify one or more parameters in the lateral control information and the longitudinal control information; and a transmitting unit configured to transmit the light control information and the modified lateral control information and longitudinal control information to a vehicle controller.

In a second aspect, according to an embodiment of the present disclosure, a computer server is provided. The computer server has the above autonomous vehicle control system provided therein.

In a third aspect, according to an embodiment of the present disclosure, an autonomous vehicle is provided. The autonomous vehicle has the above computer server provided therein.

In a fourth aspect, according to an embodiment of the present disclosure, an autonomous vehicle control method is provided. The method includes: receiving, by a receiving unit, decision information; generating, by a light control unit, light control information based on the decision information; generating, by a lateral control unit, lateral control information based on the decision information; generating, by a longitudinal control unit, longitudinal control information based on the decision information; modifying, by a modifying unit, one or more parameters in the lateral control information and the longitudinal control information; and transmitting, by a transmitting unit, the light control information and the modified lateral control information and longitudinal control information to a vehicle controller.

With the solutions of the present disclosure, when decision information is received, light control information, lateral control information, and longitudinal control information can be generated based on the decision information, thereby controlling longitudinal and lateral motions of a vehicle and enabling autonomous driving of the autonomous vehicle. In addition, one or more parameters in the calculated lateral control information and longitudinal control information are modified by a modifying unit to ensure that the parameters are in a safe range, such that dangers caused by the vehicle being controlled to move in accordance with abnormal parameters in the lateral control information and the longitudinal control information can be avoided, thereby improving safety of the vehicle while moving.

The other features and advantages of the present disclosure will be explained in the following description, and will become apparent partly from the description or be understood by implementing the present disclosure. The objects and other advantages of the present disclosure can be achieved and obtained from the structures specifically illustrated in the written description, claims and figures.

In the following, the solutions according to the present disclosure will be described in detail with reference to the figures and embodiments.

### BRIEF DESCRIPTION OF THE DRAWINGS

The figures are provided for facilitating further understanding of the present disclosure. The figures constitute a portion of the description and can be used in combination with the embodiments of the present disclosure to interpret, rather than limiting, the present disclosure. It is apparent to those skilled in the art that the figures described below only illustrate some embodiments of the present disclosure and other figures can be obtained from these figures without applying any inventive skills. In the figures:

FIG. 1 is a first diagram showing a structure of an autonomous vehicle control system according to an embodiment of the present disclosure;

FIG. 2 is a second diagram showing a structure of an autonomous vehicle control system according to an embodiment of the present disclosure;

FIG. 3 is a schematic diagram showing target waypoints according to an embodiment of the present disclosure;

FIG. 4 is a graph showing a vehicle moving from a current position to a first preview point according to an embodiment of the present disclosure;

FIG. 5 is a schematic diagram showing a modified steering wheel angle corresponding to a current speed according to an embodiment of the present disclosure;

FIG. 6 is a third diagram showing a structure of an autonomous vehicle control system according to an embodiment of the present disclosure;

FIG. 7 is a fourth diagram showing a structure of an autonomous vehicle control system according to an embodiment of the present disclosure;

FIG. 8 is a fifth diagram showing a structure of an autonomous vehicle control system according to an embodiment of the present disclosure;

FIG. 9 is a first flowchart illustrating an autonomous vehicle control method according to an embodiment of the present disclosure; and

FIG. 10 is a second flowchart illustrating an autonomous vehicle control method according to an embodiment of the present disclosure.

### DETAILED DESCRIPTION OF THE EMBODIMENTS

In the following, the solutions according to the embodiments of the present disclosure will be described clearly and completely with reference to the figures, such that the solutions can be better understood by those skilled in the art. Obviously, the embodiments described below are only some, rather than all, of the embodiments of the present disclosure. All other embodiments that can be obtained by those skilled in the art based on the embodiments described in the present disclosure without any inventive efforts are to be encompassed by the scope of the present disclosure.

### Embodiment 1

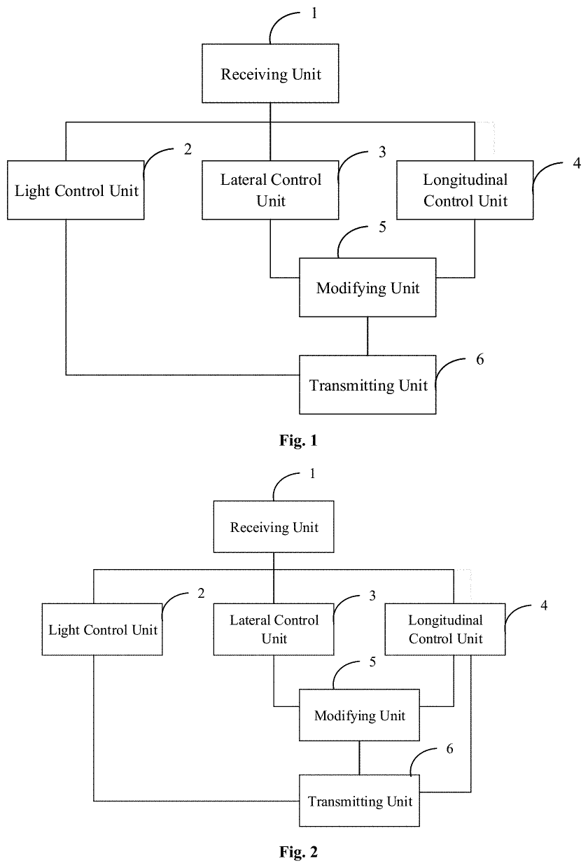

Referring to FIG. 1, which is a schematic diagram showing a structure of an autonomous vehicle control system in an embodiment of the present disclosure, the system includes a receiving unit 1, a light control unit 2, a lateral control unit 3, a longitudinal control unit 4, a modifying unit 5, and a transmitting unit 6.

The receiving unit 1 is configured to receive decision information.

The light control unit 2 is configured to generate light control information based on the decision information.

The lateral control unit 3 is configured to generate lateral control information based on the decision information.

The longitudinal control unit 4 is configured to generate longitudinal control information based on the decision information.

The modifying unit 5 is configured to modify one or more parameters in the lateral control information and the longitudinal control information.

The transmitting unit 6 is configured to transmit the light control information and the modified lateral control information and longitudinal control information to a vehicle controller.

In an embodiment of the present disclosure, the lateral control information may include steering wheel control information, and the steering wheel control information may contain a steering wheel angle.

In an embodiment of the present disclosure, the longitudinal control information may include throttle control information and brake control information. The throttle control information may include a degree of opening for a throttle pedal, and the brake control information may include acceleration.

In the system shown in FIG. 1, the longitudinal control unit 4 can transmit both the throttle control information and the brake control information to the modifying unit 5. The modifying unit 5 modifies the received brake control information and/or the received throttle control information, and transmits the modified throttle control information and brake control information to the transmitting unit 6. It can be understood that the modifying unit 5 may only modify the received brake control information, and transmit the modified brake control information and the received throttle control information to the transmitting unit 6. Of course, alternatively, the modifying unit 5 may only modify the throttle control information, and transmit the modified throttle control information and the received brake control information to the transmitting unit 6. Of course, alternatively, the modifying unit 5 may modify both the brake control information and the throttle control information. The specific implementation can be set flexibly by those skilled in the art depending on actual requirements, and the present disclosure is not limited to this.

Of course, in another example, the longitudinal control unit 4 can transmit the throttle control information directly to the transmitting unit 6, and transmit the brake control information to the modifying unit 5, and the modifying unit 5 can then modify the received brake control information and transmit it to the transmitting unit 6. Alternatively, the longitudinal control unit 4 can transmit the brake control information directly to the transmitting unit 6, and transmit the throttle control information to the modifying unit 5, and the modifying unit 5 can then modify the received throttle control information and transmit it to the transmitting unit 6, as shown in FIG. 2.

In an embodiment of the present disclosure, the decision information may include light decision information. The light decision information may include lane change information and low-beam light turn-on information. The lane change information may include, for example, turning instructions such as left turn and right turn. The low-beam light turn-on information may include a low-beam light turn-on time period (for example, the time period can be set to 19:00-5:00 in summer, or 17:00-7:00 in winter, or 18:00-6:00 in other seasons, which can be set flexibly by those skilled in the art and the present disclosure is not limited to this). Alternatively, the low-beam light turn-on information may include a low-beam light turn-on instruction and a low-beam light turn-on duration. The light control unit 2 controls the left or right light to turn on according to the lane change information, and controls the low-beam light to turn on in a predetermined time period according to the low-beam light turn on information.

Preferably, in an embodiment of the present disclosure, the lateral control unit 3 can generate the lateral control information based on the decision information in the following non-limiting scheme, which includes steps A1˜A2.

At step A1, a first preview point and a target speed for the vehicle to move from a current position to the first preview point are determined based on the decision information.

At step A2, a steering wheel angle is determined based on the current position of the vehicle and a position of the first preview point.

At step A3, the steering wheel control information containing the steering wheel angle is generated.

In some examples, the step A1 can be, but not limited to be, implemented in any of the following schemes (Schemes B1˜B2).

In Scheme B 1, the decision information contains the first preview point and the target speed, and the lateral control unit 3 obtains the first preview point and the target speed from the decision information.

In Scheme B2, the decision information contains waypoint information of a plurality of target waypoints. The lateral control unit 3 selects the first preview point from the plurality of target waypoints based on a current speed of the vehicle and the waypoint information of the plurality of target waypoints contained in the decision information, and determines a speed corresponding to the selected target waypoint as the target speed for the first preview point. The waypoint information includes a position and the speed for the target waypoint.

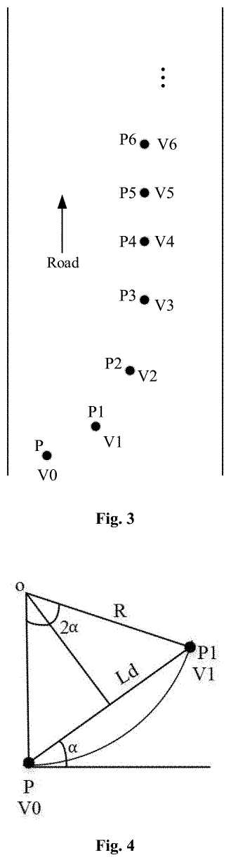

In Scheme B2, path information may include the waypoint information of the plurality of target waypoints (a target waypoint refers to a position point and in front of the vehicle on a road where the vehicle is currently located). The waypoint information of each target waypoint includes the position and the target speed for the target waypoint (the target speed is a speed at which the vehicle moves from the current position to the target waypoint). The number of target waypoints can be set flexibly depending on actual requirements, such as 40, 50, etc., and the present disclosure is not limited to this. FIG. 3 shows n target waypoints P1, P2, P3, . . . , Pn, and the target speeds corresponding to the n target waypoints are V1, V2, V3, . . . , Vn, respectively.

In Scheme B2, the first preview point can be determined as follows. First, a target distance is determined based on the current speed of the vehicle. Then, a position point having a distance from the current position that matches the target distance is selected from n target waypoints as the first preview point. Finally, the speed when the vehicle reaches the selected target waypoint is determined as the target speed when the vehicle reaches the first preview point.

For example, assuming that the current position of the vehicle is P and the current speed is V0, V0 is multiplied with a first predetermined coefficient k1 (the value of k1 can be set flexibly depending on actual requirements, for example, k1 can be set to 1, 1.5 or 2) to obtain the target distance as D=V0*k1. The target waypoint having a distance from the current position P that matches the target distance D is selected from n target waypoints as the first preview point. For example, an absolute value of a difference between the distance from each target waypoint to P and D is calculated, and the target waypoint with the smallest absolute value is selected as the first preview point. For example, P3 is selected as the first preview point.

The above step A2 can be, but not limited to be, implemented in the following scheme, which includes steps C1˜C2.

At step C1, a wheel angle is calculated based on the current position of the vehicle and the position of the first preview point using a predefined pure pursuit algorithm, a predefined Model Predictive Control (MPC) algorithm, or a predefined Linear Quadratic Regulator (LQR) algorithm.

At step C2, the steering wheel angle is calculated based on the wheel angle and a predetermined ratio between the wheel angle and the steering wheel angle.

For the pure pursuit algorithm as an example, assuming that the current position is P, the first preview point as selected is P1, the straight-line distance between P and P1 is Ld, and the vehicle moves from P to P1 along the circular curve shown in FIG. 4, the steering wheel angle can be obtained as follows.

First, Ld and angle α can be substituted into Equation (1) to obtain the value of R:

L_d/sin(2α)=2R (1)

Second, an arc curvature k can be calculated according to Equation (2):

k=2 sin α/L_d (2)

Then, the arc curvature k and the vehicle's axle distance L can be substituted into Equation (3) to obtain a front wheel angle δ:

δ=arctan(kL) (3)

Finally, the front wheel angle δ and a predetermined ratio coefficient c between the steering wheel angle and the front wheel angle can be substituted into Equation (4) to obtain the steering wheel angle θ.

θ=δ×c (4)

In an embodiment of the present disclosure, the longitudinal control unit 4 can generate the longitudinal control information based on the decision information in the following non-limiting scheme, which include steps D1˜D7.

At step D1, a second preview point and a target speed for the vehicle to move from a current position to the second preview point are determined based on the decision information.

The step D1 can be, but not limited to be, implemented in any of the following schemes (Schemes E1˜E2).

In Scheme E1, the decision information contains the second preview point and the target speed, and the longitudinal control unit 4 obtains the second preview point and the target speed from the decision information.

In Scheme E2, the decision information contains waypoint information of a plurality of target waypoints. The longitudinal control unit 4 selects the second preview point from the plurality of target waypoints based on a current speed of the vehicle and the waypoint information of the plurality of target waypoints contained in the decision information, and determines a speed corresponding to the selected target waypoint as the target speed for the second preview point. The waypoint information includes a position and the speed for the target waypoint.

In particular, the Scheme E2 can be, but not limited to be, implemented as follows. First, a target distance is determined based on the current speed of the vehicle. Then, a position point having a distance from the current position that matches the target distance is selected from n target waypoints as the second preview point. Finally, the speed when the vehicle reaches the selected target waypoint is determined as the target speed when the vehicle reaches the second preview point.

For example, assuming that the current position of the vehicle is P and the current speed is V0, V0 is multiplied with a second predetermined coefficient k2 (the value of k2 can be set flexibly depending on actual requirements, for example, k2 can be set to 1, 1.5 or 2) to obtain the target distance as D=V0*k2. The target waypoint having a distance from the current position P that matches the target distance D is selected from n target waypoints as the second preview point. For example, an absolute value of a difference between the distance from each target waypoint to P and D is calculated, and the target waypoint with the smallest absolute value is selected as the second preview point. Preferably, in an embodiment of the present disclosure, the second coefficient k2 can be larger than the first coefficient k1.

At step D2, a speed error between the current speed and the target speed for the second preview point can be calculated.

In the step D2, a difference between the target speed for the second preview point and the current speed is determined as the speed error.

At step D3, first acceleration for the vehicle to move from the current position to the second preview point is determined based on the speed error.

In the step D3, the first acceleration for the vehicle from the current position to the second preview point can be, but not limited to be, calculated based on the speed error in any of the following schemes (Schemes F1˜F3):

Scheme F1: A predefined PID algorithm can be used to calculate the speed error, so as to obtain the first acceleration.

Scheme F2: A predefined MPC algorithm can be used to calculate a target distance and the speed error, so as to obtain the first acceleration.

Scheme F3: A predefined fuzzy control algorithm can be used to calculate the speed error, so as to obtain the first acceleration.

At step D4, the first acceleration is inputted to a predetermined longitudinal dynamics model of the vehicle to obtain a wheel torque.

In an embodiment of the present disclosure, the principle of the longitudinal dynamics model of the vehicle can be as follows. First, a resistance f received by the vehicle is obtained. Second, the resistance f, the first acceleration a, and mass m of the vehicle are inputted to Equation (5) below to calculate a driving force F. The driving force F and a rolling radius of a wheel are inputted to Equation (6) to calculate a wheel torque T of the wheel. Equation (5) and Equation (6) are as follows:

F=f+ma (5)

where F is the driving force, f is the resistance received by the vehicle, m is the mass of the vehicle, and a is the first acceleration.

T=F/r (6)

where F is the driving force, T is the wheel torque, and r is the rolling radius of the wheel.

In an embodiment of the present disclosure, the resistance f received by the vehicle may include a sum of any one or more of the following resistance: ground friction resistance, wind resistance, and slope resistance. Different types of roads, such as asphalt roads, cement roads, snow roads, icy roads, mud roads, etc., have different friction coefficients. A ground image captured by a camera sensor can be identified using an image identification algorithm to obtain a road type of the current road where the vehicle is located. The road type can be transmitted to the longitudinal dynamics model of the vehicle, such that the longitudinal dynamics model of the vehicle can select a corresponding friction coefficient based on the road type to calculate the ground friction resistance. The wind resistance is proportional to a windward area and a square of the speed of the vehicle. The slope information of the road can be measured by a vehicle-mounted sensor.

At step D5, it is determined whether the first acceleration is greater than 0. If so, the method proceeds with step D6, or otherwise the method proceeds with step D7.

At step D6, a degree of opening for a throttle pedal is determined based on the wheel torque, and throttle control information containing the degree of opening for the throttle pedal is generated.

In the step D6, the transmission ratio c is a ratio of the wheel torque to the engine torque. The transmission ratio is a known parameter. The wheel torque T and the transmission ratio c can be inputted to Equation (7) below to calculate the engine torque T′:

T′=T/c (7)

In an embodiment of the present disclosure, a table can be predefined (denoted as a first table hereinafter), and a first correspondence among engine speeds (an engine speed can be directly detected by a sensor, or a wheel speed can be calculated first based on the vehicle speed, and then an engine speed can be calculated based on the wheel speed and the transmission ratio), engine torques and degrees of opening for the throttle pedal can be provided in the first table. In the step D6, the first table can be searched for the value of the first degree of opening for the throttle pedal corresponding to the engine torque T′ calculated using Equation (7) and the current engine speed of the vehicle. If the value of the degree of opening for the throttle pedal corresponding to T′ and the current engine speed of the vehicle cannot be found in the first table, a linear interpolation algorithm can be used to interpolate the engine torques, engine speeds and degree of opening for the throttle pedal in the first table to obtain the degree of opening for the throttle pedal corresponding to T′ and the current engine speed of the vehicle.

At step D7, first brake control information containing the first acceleration is generated.

In the above embodiment, the modifying unit 5 can modify one or more parameters in the brake control information in the following non-limiting scheme, which includes steps G1˜G2.

At step G1, it is determined whether an absolute value of the first acceleration in the first brake control information is greater than a predetermined acceleration threshold. If so, the scheme proceeds with step G2, or otherwise, the first acceleration is not adjusted.

At step G2, the absolute value of the first acceleration is adjusted to be same as the acceleration threshold. For example, if the value of the first acceleration is −10 m/s\hat{ }2 and the acceleration threshold is 6 m/s\hat{ }2, the value of the first acceleration is adjusted to −6 m/s\hat{ }2.

Preferably, in order to prevent the vehicle from sliding while stopping, in an embodiment of the present disclosure, the modifying unit 5 can be further configured to: determine whether the current speed and the first acceleration are both zero, and if so, generate a second brake control instruction containing a predetermined brake pressure for preventing the vehicle from sliding, and transmit the second brake control instruction to the transmitting unit 6. Accordingly, the transmitting unit 6 can be further configured to transmit the second brake control instruction to the vehicle controller.

In an embodiment of the present disclosure, the modifying unit 5 can modify one or more parameters in the lateral control information in the following non-limiting scheme, which includes steps H1˜H3.

At step H1, a current speed of the vehicle is matched with a plurality of speed ranges to determine a target speed range containing the current speed of the vehicle.

At step H2, it is determined whether the steering wheel angle in the steering wheel control information falls within a steering wheel angle range corresponding to the target speed range. Here, a speed range having a larger value corresponds to a smaller steering wheel angle. If not, the scheme proceeds with step H3; otherwise the steering wheel angle is not adjusted.

At step H3, the steering wheel angle is adjusted to fall within the steering wheel angle range.

In an embodiment of the present disclosure, a plurality of speed ranges can be predetermined, and a corresponding steering wheel angle range can be set for each speed range in advance, indicating that the steering wheel angle cannot fall outside the steering wheel angle range corresponding to the speed range to which the current speed belongs while the vehicle is moving. For example, in order to prevent the vehicle from turning sharply while moving at a high speed, in an embodiment of the present disclosure, a speed range having a larger value corresponds to a smaller steering wheel angle. For example, the steering wheel angle corresponding to the speed range [80, 100] can be [10°, 5° ], the steering wheel angle corresponding to the speed range [60, 80] can be [15°, 10° ], the steering wheel angle corresponding to the speed range [40, 60] can be [20°, 15° ], and the steering wheel angle corresponding to the speed range [0, 40] can be [25°, 20° ].

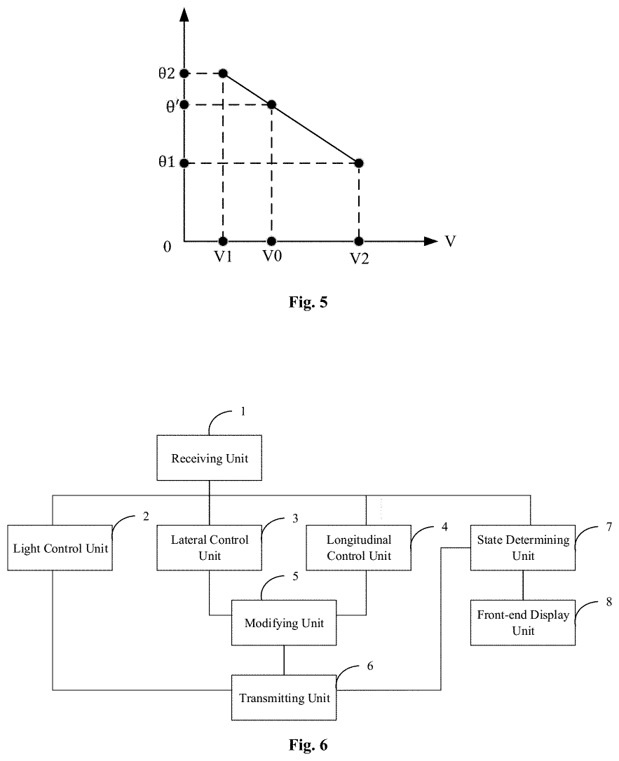

In the step H3, the steering wheel angle can be adjusted to be a lower limit or upper limit of the steering wheel angle range corresponding to the target speed range. Alternatively, the steering wheel angle can be adjusted using a linear interpolation algorithm. As shown in FIG. 5, assuming that the current speed is V0, the steering wheel angle before modification is 0, the target speed range is [V1, V2], and the steering wheel angle range corresponding to the target speed range is [θ1, θ2], the modified steering wheel angle corresponding to the current speed V0 can be obtained as θ′ using the linear interpolation algorithm.

In an application scenario, an autonomous driving system for an autonomous vehicle may include an upper-layer computing server and a lower-layer computing server. The upper-layer computing server is responsible for high-precision mapping, perception, and execution of a decision program to generate the decision information. The system shown in FIG. 1 or FIG. 2 according to Embodiment 1 can operate in the lower-layer computing server. The upper-layer computing server and the lower-layer computing server can communicate with each other using, but not limited to using, any one or more of the following communication schemes: Controller Area Network (CAN), Bluetooth, infrared, V2X communication, WIFI, ZigBee, USB, or other currently common communication schemes.

The receiving unit 1 can receive the decision information from the upper-layer computing server, decode the received decision information, and transmit the decoded decision information to other units as described above.

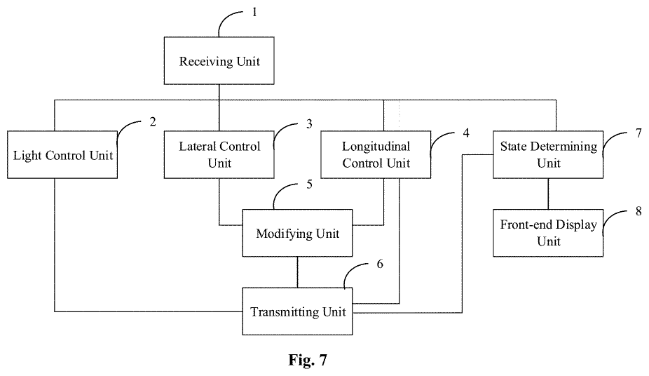

Preferably, in order to allow the upper-layer computing server and the lower-layer computing server to understand each other's operational state in time, in an embodiment of the present disclosure, the decision information can further include state information of the upper-layer computing server (e.g., normal operation, abnormal operation, etc.). In this case, the system may further include a state determining unit 7 and a front-end display unit 8. FIG. 6 shows a system shown in FIG. 1 further including a state determining unit 7 and a front-end display unit 8. FIG. 7 shows a system shown in FIG. 2 further including a state determining unit 7 and a front-end display unit 8.

The receiving unit 1 can be further configured to transmit the decision information to the state determining unit 7.

The front-end display unit 8 can be configured to provide a human-computer interaction interface, and transmit a control parameter inputted by a user on the human-computer interaction interface for turning on or off the system to the state determining unit 7.

The state determining unit 7 can be configured to determine current state information of the lower-layer computing server based on the state information of the upper-layer computing server and the control parameter transmitted from the front-end display unit 8, and transmit the current state information to the transmitting unit 6.

The state information of the lower-layer computing server indicates whether the lower-layer computing server is operating normally.

The transmitting unit 6 can be further configured to transmit the current state information of the lower-layer computing server to the upper-layer computing server.

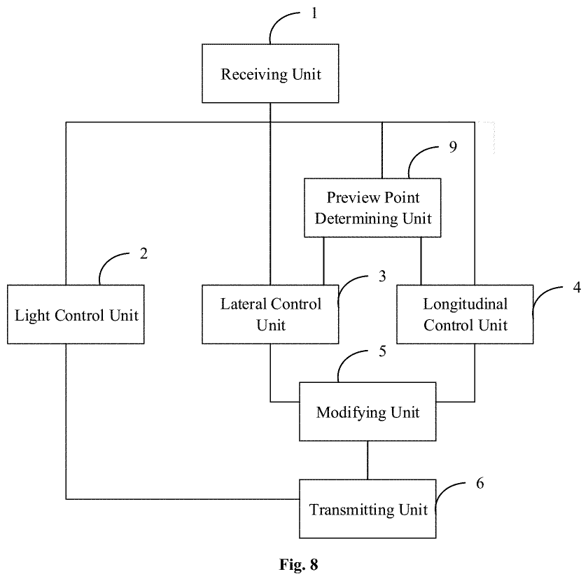

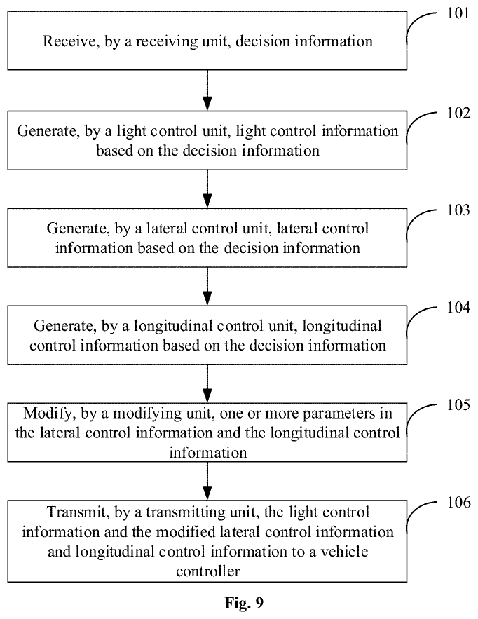

Of course, for the above systems shown in FIG. 1, FIG. 2, FIG. 6, and FIG. 7, some embodiments of the present disclosure may also provide some alternatives. In the lateral control unit 3 and the longitudinal control unit 4, the first preview point and the second preview point may be the same. These systems may further include a preview point determining unit 9 configured to determine a preview point and a target speed for the vehicle to move from the current position to the preview point based on the decision information, and transmit the preview point and its target speed to the lateral control unit 3 and the longitudinal control unit 4. The lateral control unit 3 and the longitudinal control unit 4 can directly use the preview point and the target speed determined by the preview point determining unit 9. The lateral control unit 3 can generate the steering wheel control information based on the decision information by: determining the steering wheel angle based on the current position of the vehicle and the position of the preview point, and generating the steering wheel control information containing the steering wheel angle. The longitudinal control unit 4 can generate the throttle control information and the brake control information based on the decision information by: calculating the speed error between the current speed of the vehicle and the target speed for the second preview point; determining the first acceleration for the vehicle to move from the current position to the second preview point; inputting the first acceleration to the predetermined longitudinal dynamics model of the vehicle to obtain a wheel torque; determining whether the first acceleration is greater than 0; and if so, determining a degree of opening for a throttle pedal based on the wheel torque and generating throttle control information containing the degree of opening for the throttle pedal; or otherwise generating first brake control information containing the first acceleration. As shown in FIG. 8, the system shown in FIG. 1 may further include a preview point determining unit 9.

The receiving unit 1 can be further configured to transmit the decision information to the preview point determining unit 9.

The preview point determining unit 9 can be configured to determine a preview point and a target speed for the vehicle to move from the current position to the preview point based on the decision information, and transmit the preview point and its target speed to the lateral control unit 3 and the longitudinal control unit 4.

The preview point determining unit 9 can be configured to determine the preview point and its target speed by using the same principle as in described in the above step A1, and details thereof will be omitted here.

### Embodiment 2

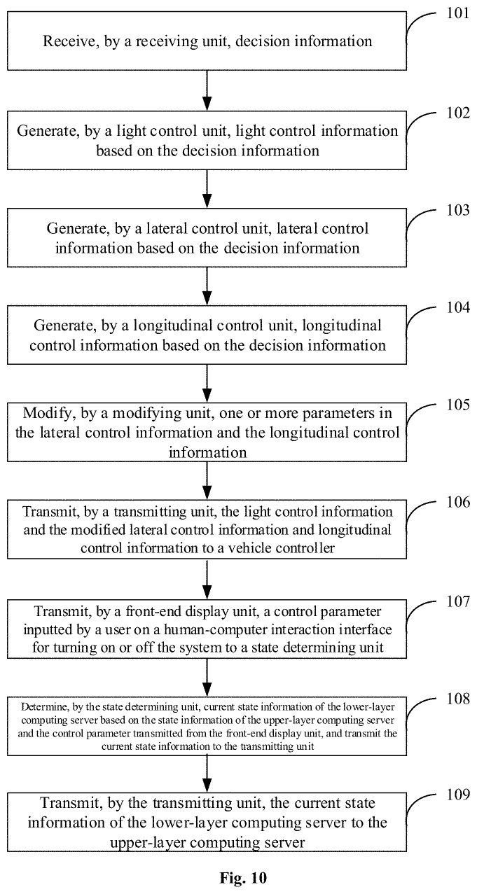

Based on the same concept as the autonomous vehicle control system according to Embodiment 1, Embodiment 2 of the present disclosure provides an autonomous vehicle control method. The process flow of the method is shown in FIG. 9 and includes the following steps.

At step 101, a receiving unit receives decision information.

At step 102, a light control unit generates light control information based on the decision information.

At step 103, a lateral control unit generates lateral control information based on the decision information.

At step 104, a longitudinal control unit generates longitudinal control information based on the decision information.

At step 105, a modifying unit modifies one or more parameters in the lateral control information and the longitudinal control information.

At step 106, a transmitting unit transmits the light control information and the modified lateral control information and longitudinal control information to a vehicle controller.

In an embodiment of the present disclosure, there is no strict order for performing the above steps 102, 103, and 104.

In an embodiment of the present disclosure, the lateral control information may include steering wheel control information, and the steering wheel control information may contain a steering wheel angle.

In an embodiment of the present disclosure, the longitudinal control information may include throttle control information and brake control information. The throttle control information may include a degree of opening for a throttle pedal. The brake control information may include acceleration.

In the method shown in FIG. 9, in the step 104, the longitudinal control unit 4 can transmit both the throttle control information and the brake control information to the modifying unit 5. The modifying unit 5 modifies the received brake control information and/or the received throttle control information, and transmits the modified throttle control information and brake control information to the transmitting unit 6. It can be understood that the modifying unit 5 may only modify the received brake control information, and transmit the modified brake control information and the received throttle control information to the transmitting unit 6. Of course, alternatively, the modifying unit 5 may only modify the throttle control information, and transmit the modified throttle control information and the received brake control information to the transmitting unit 6. Of course, alternatively, the modifying unit 5 may modify both the brake control information and the throttle control information. The specific implementation can be set flexibly by those skilled in the art depending on actual requirements, and the present disclosure is not limited to this.

Of course, in another example, the longitudinal control unit 4 can transmit the throttle control information directly to the transmitting unit 6, and transmit the brake control information to the modifying unit 5, and the modifying unit 5 can then modify the received brake control information and transmit it to the transmitting unit 6. Alternatively, the longitudinal control unit 4 can transmit the brake control information directly to the transmitting unit 6, and transmit the throttle control information to the modifying unit 5, and the modifying unit 5 can then modify the received throttle control information and transmit it to the transmitting unit 6.

In an embodiment of the present disclosure, the decision information may include light decision information. The light decision information may include lane change information and low-beam light turn-on information. The lane change information may include, for example, turning instructions such as left turn and right turn. The low-beam light turn-on information may include a low-beam light turn-on time period (for example, the time period can be set to 19:00-5:00 in summer, or 17:00-7:00 in winter, or 18:00-6:00 in other seasons, which can be set flexibly by those skilled in the art and the present disclosure is not limited to this). Alternatively, the low-beam light turn-on information may include a low-beam light turn-on instruction and a low-beam light turn-on duration. The light control unit 2 controls the left or right light to turn on according to the lane change information, and controls the low-beam light to turn on in a predetermined time period according to the low-beam light turn on information.

Preferably, the step 103 may be implemented in the following scheme (including steps 103a˜103c, which correspond to the steps A1˜A3 in Embodiment 1, and details thereof will be omitted here).

At step 103a, a first preview point and a target speed for the vehicle to move from a current position to the first preview point are determined based on the decision information.

At step 103b, a steering wheel angle is determined based on the current position of the vehicle and a position of the first preview point.

At step 103c, the steering wheel control information containing the steering wheel angle is generated.

In particular, the step 103a can be implemented in Scheme B1 or Scheme B2 of Embodiment 1, and details thereof will be omitted here.

In particular, the step 103b can be implemented according to the steps C1˜C2 in Embodiment 1, and details thereof will be omitted here.

In an embodiment of the present disclosure, the step 104 can be, but not limited to be, implemented in the following scheme including steps 104a˜104g, which correspond to the steps D1˜D7 in Embodiment 1, and details thereof will be omitted here.

At step 104a, a second preview point and a target speed for the vehicle to move from a current position to the second preview point are determined based on the decision information.

At step 104b, a speed error between the current speed and the target speed for the second preview point can be calculated.

At step 104c, first acceleration for the vehicle to move from the current position to the second preview point is determined based on the speed error.

At step 104d, the first acceleration is inputted to a predetermined longitudinal dynamics model of the vehicle to obtain a wheel torque.

At step 104e, it is determined whether the first acceleration is greater than 0. If so, the method proceeds with step 104f, or otherwise the method proceeds with step 104g.

At step 104f, a degree of opening for a throttle pedal is determined based on the wheel torque, and throttle control information containing the degree of opening for the throttle pedal is generated.

At step 104g, first brake control information containing the first acceleration is generated.

In particular, the step 104a can be implemented in any of Schemes E1˜E2 in Embodiment 1, and details thereof will be omitted here.

In particular, the step 104c can be implemented in any of Schemes F1˜F3 in Embodiment 1, and details thereof will be omitted here.

In an embodiment of the present disclosure, in the step 105, the modifying unit can modify one or more parameters in the longitudinal control information in the following non-limiting scheme including steps 105a˜105b, which correspond to the steps G1˜G2 in Embodiment 1, respectively, and details thereof will be omitted here.

At step 105a, it is determined whether an absolute value of the first acceleration in the first brake control information is greater than a predetermined acceleration threshold. If so, the scheme proceeds with step 105b, or otherwise, the first acceleration is not adjusted.

At step 105b, the absolute value of the first acceleration is adjusted to be same as the acceleration threshold.

Preferably, in an embodiment of the present disclosure, in the above step 105, the modifying unit can modify one or more parameters in the lateral control information in the following non-limiting scheme including steps 105c˜105e, which correspond to the steps H1˜H3 in Embodiment 1, respectively, and details thereof will be omitted here.

At step 105c, a current speed of the vehicle is matched with a plurality of speed ranges to determine a target speed range containing the current speed of the vehicle.

At step 105d, it is determined whether the steering wheel angle in the steering wheel control information falls within a steering wheel angle range corresponding to the target speed range. Here, a speed range having a larger value corresponds to a smaller steering wheel angle. If not, the scheme proceeds with step 105e; otherwise the steering wheel angle is not adjusted.

At step 105e, the steering wheel angle is adjusted to fall within the steering wheel angle range.

Preferably, in an embodiment of the present disclosure, the decision information can further include state information of an upper-layer computing server. The above method shown in FIG. 9 may further include steps 107˜109, as shown in FIG. 10.

The step 101 may further include the receiving unit transmitting the decision information to a state determining unit.

At step 107, a front-end display unit transmits a control parameter inputted by a user on a human-computer interaction interface for turning on or off the system to the state determining unit.

At step 108, the state determining unit determines current state information of the lower-layer computing server based on the state information of the upper-layer computing server and the control parameter transmitted from the front-end display unit, and transmits the current state information to the transmitting unit.

At step 109, the transmitting unit transmits the current state information of the lower-layer computing server to the upper-layer computing server.

In an embodiment of the present disclosure, the steps 107 to 109 as a whole can be performed before or after any one of the steps shown in FIG. 9.

Of course, for the above methods shown in FIGS. 9 and 10, some embodiments of the present disclosure may also provide some alternatives. In the lateral control unit and the longitudinal control unit, the first preview point and the second preview point may be the same. A preview point determining unit can determine a preview point and a target speed for the vehicle to move from the current position to the preview point based on the decision information, and transmit the preview point and its target speed to the lateral control unit and the longitudinal control unit. The lateral control unit and the longitudinal control unit can directly use the preview point and the target speed determined by the preview point determining unit. The lateral control unit can generate the steering wheel control information based on the decision information by: determining the steering wheel angle based on the current position of the vehicle and the position of the preview point, and generating the steering wheel control information containing the steering wheel angle. The longitudinal control unit can generate the throttle control information and the brake control information based on the decision information by: calculating the speed error between the current speed of the vehicle and the target speed for the second preview point; determining the first acceleration for the vehicle to move from the current position to the second preview point; inputting the first acceleration to the predetermined longitudinal dynamics model of the vehicle to obtain a wheel torque; determining whether the first acceleration is greater than 0; and if so, determining a degree of opening for a throttle pedal based on the wheel torque and generating throttle control information containing the degree of opening for the throttle pedal; or otherwise generating first brake control information containing the first acceleration.

### Embodiment 3

Embodiment 3 of the present disclosure provides a computer server, having any one of the autonomous vehicle control systems disclosed in the above Embodiment 1 provided therein.

The computer server may include a Digital Signal Processor (DSP), a Field-Programmable Gate Array (FPGA) controller, a desktop computer, a mobile computer, a PAD, a single-chip computer or other hardware devices. The receiving unit 1 and the transmitting unit 6 can be implemented by a communication module, such as an antenna, on the computer server. The light control unit 2, the lateral control unit 3, the longitudinal control unit 4, and the modifying unit 5 may be provided in a processor, such as a CPU, in the computer server.

The computer server can be provided on all types of autonomous vehicles and advanced assisted driving vehicles, such as trucks, freight vehicles, buses, passenger cars, trailers, sprinklers, bicycles, etc., for controlling autonomous driving of the autonomous vehicles.

The basic principles of the present disclosure have been described above with reference to the embodiments. However, it can be appreciated by those skilled in the art that all or any of the steps or components of the method or device according to the present disclosure can be implemented in hardware, firmware, software or any combination thereof in any computing device (including a processor, a storage medium, etc.) or a network of computing devices. This can be achieved by those skilled in the art using their basic programming skills based on the description of the present disclosure.

It can be appreciated by those skilled in the art that all or part of the steps in the method according to the above embodiment can be implemented in hardware following instructions of a program. The program can be stored in a computer readable storage medium. The program, when executed, may include one or any combination of the steps in the method according to the above embodiment.

Further, the functional units in the embodiments of the present disclosure can be integrated into one processing module or can be physically separate, or two or more units can be integrated into one module. Such integrated module can be implemented in hardware or software functional units. When implemented in software functional units and sold or used as a standalone product, the integrated module can be stored in a computer readable storage medium.

It can be appreciated by those skilled in the art that the embodiments of the present disclosure can be implemented as a method, a system or a computer program product. The present disclosure may include pure hardware embodiments, pure software embodiments and any combination thereof. Also, the present disclosure may include a computer program product implemented on one or more computer readable storage mediums (including, but not limited to, magnetic disk storage and optical storage) containing computer readable program codes.

The present disclosure has been described with reference to the flowcharts and/or block diagrams of the method, device (system) and computer program product according to the embodiments of the present disclosure. It can be appreciated that each process and/or block in the flowcharts and/or block diagrams, or any combination thereof, can be implemented by computer program instructions. Such computer program instructions can be provided to a general computer, a dedicated computer, an embedded processor or a processor of any other programmable data processing device to constitute a machine, such that the instructions executed by a processor of a computer or any other programmable data processing device can constitute means for implementing the functions specified by one or more processes in the flowcharts and/or one or more blocks in the block diagrams.

These computer program instructions can also be stored in a computer readable memory that can direct a computer or any other programmable data processing device to operate in a particular way. Thus, the instructions stored in the computer readable memory constitute a manufacture including instruction means for implementing the functions specified by one or more processes in the flowcharts and/or one or more blocks in the block diagrams.

These computer program instructions can also be loaded onto a computer or any other programmable data processing device, such that the computer or the programmable data processing device can perform a series of operations/steps to achieve a computer-implemented process. In this way, the instructions executed on the computer or the programmable data processing device can provide steps for implementing the functions specified by one or more processes in the flowcharts and/or one or more blocks in the block diagrams.

While the embodiments of the present disclosure have described above, further alternatives and modifications can be made to these embodiments by those skilled in the art in light of the basic inventive concept of the present disclosure. The claims as attached are intended to cover the above embodiments and all these alternatives and modifications that fall within the scope of the present disclosure.

Obviously, various modifications and variants can be made to the present disclosure by those skilled in the art without departing from the spirit and scope of the present disclosure. Therefore, these modifications and variants are to be encompassed by the present disclosure if they fall within the scope of the present disclosure as defined by the claims and their equivalents.

What is claimed is:

1. An autonomous vehicle control system, comprising:
a receiving unit configured to receive decision information;
a light control unit configured to generate light control information based on the decision information;
a lateral control unit configured to generate lateral control information based on the decision information;
a longitudinal control unit configured to generate longitudinal control information based on the decision information;
a modifying unit configured to modify one or more parameters in the lateral control information and the longitudinal control information; and
a transmitting unit configured to transmit the light control information and the modified lateral control information and longitudinal control information to a vehicle controller.

2. The system of claim 1, wherein the lateral control information comprises steering wheel control information, and the lateral control unit being configured to generate the lateral control information based on the decision information comprises the lateral control unit being configured to:
determine a first preview point and a target speed for the vehicle to move from a current position to the first preview point based on the decision information;
determine a steering wheel angle based on the current position of the vehicle and a position of the first preview point;
generate the steering wheel control information containing the steering wheel angle.

3. The system of claim 2, wherein the lateral control unit being configured to determine the steering wheel angle based on the current position of the vehicle and the position of the first preview point comprises the lateral control unit being configured to:
calculate a wheel angle based on the current position of the vehicle and the position of the first preview point using a predefined pure pursuit algorithm, a predefined Model Predictive Control (MPC) algorithm, or a predefined Linear Quadratic Regulator (LQR) algorithm;
calculate the steering wheel angle based on the wheel angle and a predetermined ratio between the wheel angle and the steering wheel angle.

4. The system of claim 3, wherein the lateral control unit being configured to determine the first preview point and the target speed for the vehicle to move from the current position to the first preview point based on the decision information comprises the lateral control unit being configured to:
select the first preview point from a plurality of target waypoints based on a current speed of the vehicle and waypoint information of the plurality of target waypoints contained in the decision information, and determine a speed corresponding to the selected target waypoint as the target speed for the first preview point, wherein the waypoint information comprises a position and the speed for the target waypoint; or
obtain the first preview point and the target speed from the decision information.

5. The system of claim 2, wherein the modifying unit being configured to modify one or more parameters in the lateral control information comprises the modifying unit being configured to:
match a current speed of the vehicle with a plurality of speed ranges to determine a target speed range containing the current speed of the vehicle;
determine whether the steering wheel angle in the steering wheel control information falls within a steering wheel angle range corresponding to the target speed range, wherein a speed range having a larger value corresponds to a smaller steering wheel angle; and
if not, adjust the steering wheel angle to fall within the steering wheel angle range.

6. The system of claim 1, wherein the longitudinal control information comprises throttle control information and brake control information, and the longitudinal control unit being configured to generate the longitudinal control information based on the decision information comprises the longitudinal control unit being configured to:
determine a second preview point and a target speed for the vehicle to move from a current position to the second preview point based on the decision information;
calculate a speed error between a current speed of the vehicle and the target speed for the second preview point;
determine first acceleration for the vehicle to move from the current position to the second preview point based on the speed error;
input the first acceleration to a predetermined longitudinal dynamics model of the vehicle to obtain a wheel torque;
determine whether the first acceleration is greater than 0; and
if so, determine a degree of opening for a throttle pedal based on the wheel torque, and generate the throttle control information containing the degree of opening for the throttle pedal, or
otherwise generate first brake control information containing the first acceleration.

7. The system of claim 6, wherein the longitudinal control unit being configured to determine the second preview point and the target speed for the vehicle to move from the current position to the second preview point based on the decision information comprises the longitudinal control unit being configured to:
select the second preview point from a plurality of target waypoints based on a current speed of the vehicle and waypoint information of the plurality of target waypoints contained in the decision information, and determine a speed corresponding to the selected target waypoint as the target speed for the second preview point, wherein the waypoint information comprises a position and the speed for the target waypoint; or
obtain the second preview point and the target speed from the decision information.

8. The system of claim 6, wherein the modifying unit being configured to modify one or more parameters in the longitudinal control information comprises the modifying unit being configured to:
determine whether an absolute value of the first acceleration in the first brake control information is greater than a predetermined acceleration threshold;
if so, adjust the absolute value of the first acceleration to be same as the acceleration threshold.

9. The system of claim 8, wherein the modifying unit is further configured to: determine whether the current speed and the first acceleration are both zero, and if so, generate a second brake control instruction containing a brake pressure for preventing the vehicle from sliding, and transmit the second brake control instruction to the transmitting unit, and
the transmitting unit is further configured to transmit the second brake control instruction to the vehicle controller.

10. The system of claim 1, wherein the system operates in a lower-layer computing server and the receiving unit receives the decision information from an upper-layer computing server, and the decision information further comprises state information of the upper-layer computing server, and
the system further comprises a state determining unit and a front-end display unit, wherein:
the receiving unit is further configured to transmit the decision information to the state determining unit,
the front-end display unit is configured to provide a human-computer interaction interface, and transmit a control parameter inputted by a user on the human-computer interaction interface for turning on or off the system to the state determining unit,
the state determining unit is configured to determine current state information of the lower-layer computing server based on the state information of the upper-layer computing server and the control parameter transmitted from the front-end display unit, and transmit the current state information to the transmitting unit, and
the transmitting unit is further configured to transmit the current state information of the lower-layer computing server to the upper-layer computing server.

11. A computer server, having the autonomous vehicle control system of claim 1 provided therein.

12. An autonomous vehicle, having the computer server of claim 11 provided therein.

13. An autonomous vehicle control method, comprising:
receiving, by a receiving unit, decision information;
generating, by a light control unit, light control information based on the decision information;
generating, by a lateral control unit, lateral control information based on the decision information;
generating, by a longitudinal control unit, longitudinal control information based on the decision information;
modifying, by a modifying unit, one or more parameters in the lateral control information and the longitudinal control information; and
transmitting, by a transmitting unit, the light control information and the modified lateral control information and longitudinal control information to a vehicle controller.

14. The method of claim 13, wherein the lateral control information comprises steering wheel control information, and the lateral control unit generating the lateral control information based on the decision information comprises:
determining a first preview point and a target speed for the vehicle to move from a current position to the first preview point based on the decision information;
determining a steering wheel angle based on the current position of the vehicle and a position of the first preview point;
generating the steering wheel control information containing the steering wheel angle.

15. The method of claim 14, wherein the lateral control unit determining the steering wheel angle based on the current position of the vehicle and the position of the first preview point comprises:
calculating a wheel angle based on the current position of the vehicle and the position of the first preview point using a predefined pure pursuit algorithm, a predefined Model Predictive Control (MPC) algorithm, or a predefined Linear Quadratic Regulator (LQR) algorithm;
calculating the steering wheel angle based on the wheel angle and a predetermined ratio between the wheel angle and the steering wheel angle.

16. The method of claim 14, wherein the modifying unit modifying one or more parameters in the lateral control information comprises:
matching a current speed of the vehicle with a plurality of speed ranges to determine a target speed range containing the current speed of the vehicle;
determining whether the steering wheel angle in the steering wheel control information falls within a steering wheel angle range corresponding to the target speed range, wherein a speed range having a larger value corresponds to a smaller steering wheel angle; and
if not, adjusting the steering wheel angle to fall within the steering wheel angle range.

17. The method of claim 13, wherein the longitudinal control information comprises throttle control information and brake control information, and the longitudinal control unit generating the longitudinal control information based on the decision information comprises:
determining a second preview point and a target speed for the vehicle to move from a current position to the second preview point based on the decision information;
calculating a speed error between a current speed of the vehicle and the target speed for the second preview point;
determining first acceleration for the vehicle to move from the current position to the second preview point based on the speed error;
inputting the first acceleration to a predetermined longitudinal dynamics model of the vehicle to obtain a wheel torque;
determining whether the first acceleration is greater than 0; and
if so, determining a degree of opening for a throttle pedal based on the wheel torque, and generating the throttle control information containing the degree of opening for the throttle pedal, or
otherwise generating first brake control information containing the first acceleration.

18. The method of claim 17, wherein the modifying unit modifying one or more parameters in the longitudinal control information comprises:
determining whether an absolute value of the first acceleration in the first brake control information is greater than a predetermined acceleration threshold;
if so, adjusting the absolute value of the first acceleration to be same as the acceleration threshold.

19. The method of claim 13, wherein the method is executed in a lower-layer computing server and the decision information further comprises state information of an upper-layer computing server, and the method further comprises:
transmitting, by the receiving unit, the decision information to a state determining unit;
transmitting, by a front-end display unit, a control parameter inputted by a user on a human-computer interaction interface for turning on or off the system to the state determining unit;
determining, by the state determining unit, current state information of the lower-layer computing server based on the state information of the upper-layer computing server and the control parameter transmitted from the front-end display unit, and transmitting the current state information to the transmitting unit, and
transmitting, by the transmitting unit, the current state information of the lower-layer computing server to the upper-layer computing server.
